(19) United States
(12) Patent Application Publication
(10) Pub. No.: US 2008/0156514 A1
(43) Pub. Date: Jul. 3, 2008

(54) Adjustable Electrical Box Assembly

(76) Inventor: Ronald D. Webb, Pasadena, CA (US)

Correspondence Address: BANNER & WITCOFF, LTD., TEN SOUTH WACKER DRIVE, SUITE 3000, CHICAGO, IL, 60606, US

(21) Appl. No.: 11/955,584

(22) Filed: Dec. 13, 2007

Related U.S. Application Data
(60) Provisional application No. 60/882,046, filed on Dec. 27, 2006.

(51) Int. Cl. H02G 3/12

(52) U.S. Cl. 174/58

(57) ABSTRACT

An electrical box assembly including a mounting plate having an opening defined therein, a subassembly including a box ring and an electrical box functionally connected to one another, the box ring being slidably received within the opening, and at least one adjustment member interconnecting the subassembly and the mounting plate and selectively adjusting a relative position thereof.

### FIELD OF THE INVENTION

The present invention relates to electrical equipment in buildings, more particularly to electrical box assemblies.

### BACKGROUND OF THE INVENTION

In residential, commercial and industrial buildings, power distribution systems generally include a plurality of electrical box assemblies connected to the building's power supply and each including an electrical component such as for example a switch, a socket, an electrical motor, a speaker or a horn. These electrical box assemblies are usually mounted in a cavity between two walls of a partition, and openings are defined in the wall covering of the partition to provide access to each electrical component.

Typical electrical box assemblies include a mounting plate fixed to a wall stud or a floor member, an electrical box attached to a rear side of the mounting plate and having one open end aligned with an opening of the mounting plate, a box ring attached to a front side of the mounting plate in alignment with the electrical box, and an electrical component received in the box ring and/or the electrical box. The box ring usually extends through the respective opening defined in the wall covering of the partition. As such, the mounting plate must be placed within the partition such that the front surface of the box ring does not extend beyond the outer surface of the wall covering, while being substantially close thereto. The position of the mounting plate can be difficult to determine, as it is generally installed before the wall covering is put in place.

In addition, the thickness of the wall covering can vary within a building, generally necessitating different electrical box assemblies for example including box rings of various depths, thus increasing the complexity of the installation of the power distribution system. As such, the skilled worker installing the power distribution system generally needs to be aware of the type of wall covering to be installed later on the wall partition. Errors in communication, as well as design changes, can necessitate the position and/or type of the electrical box assembly to be changed after its initial installation, increasing the cost and time of the building construction process. In addition, when a wall covering is changed after the construction of the building, the depth of the existing box ring may no longer be adequate and as such the box ring may need to be changed, again increasing the time and costs of the work.

While some electrical box assemblies exist which permit some adjustability of the box ring to accommodate various different wall thicknesses, this is typically done by providing the box ring with an extending member which must be in good electrical contact with the box ring through its range of travel. Further, these extending members are engaged with the rest of the assembly and adjusted relative thereto by screws which are internally mounted within the box ring and the electrical box. Accordingly, such adjustable designs are undesirable as the internally mounted adjustment screws can interfere with the internal wiring and/or electrical components.

Accordingly, improvements are desirable.

### SUMMARY OF INVENTION

It is therefore an aim of the present invention to provide an improved electrical box assembly.

Therefore, in accordance with the present invention, there is provided an electrical box assembly comprising a mounting plate having an opening defined therein, a box ring having a wall defining a closed perimeter and opposed open ends, the wall being slidably received within the opening of the mounting plate, and a flange extending outwardly from the wall around one of the open ends of the box ring, and at least one adjustment member interconnecting the flange and the mounting plate and selectively adjusting a distance therebetween.

Also in accordance with the present invention, there is provided an electrical box assembly comprising a mounting plate having an opening defined therein, a subassembly including a box ring and an electrical box functionally connected to one another, the box ring being slidably received within the opening, and at least one adjustment member interconnecting the subassembly and the mounting plate and selectively adjusting a relative position thereof.

Further in accordance with the present invention, there is provided an electrical box assembly comprising a box ring having a wall defining a closed perimeter and opposed first and second open ends, and a plate portion connected substantially perpendicularly to the wall to define a flange extending outwardly around the first open end, and an electrical box having at least a third open end, the electrical box being directly attached to the plate portion with the first and third open ends aligned with one another.

### BRIEF DESCRIPTION OF THE DRAWINGS

Reference will now be made to the accompanying drawings, showing by way of illustration a particular embodiment of the present invention and in which:

FIG. 1 is a perspective exploded view of an electrical box assembly according to a particular embodiment of the present invention;

FIG. 2 is a perspective view of an electrical box assembly according to another embodiment of the present invention, with an electrical box thereof omitted for improved clarity; and

FIG. 3 is a perspective view of the electrical box assembly of FIG. 2 with the electrical box shown, showing the box ring at a different position relative to the mounting plate of the assembly.

### DETAILED DESCRIPTION OF PARTICULAR EMBODIMENTS

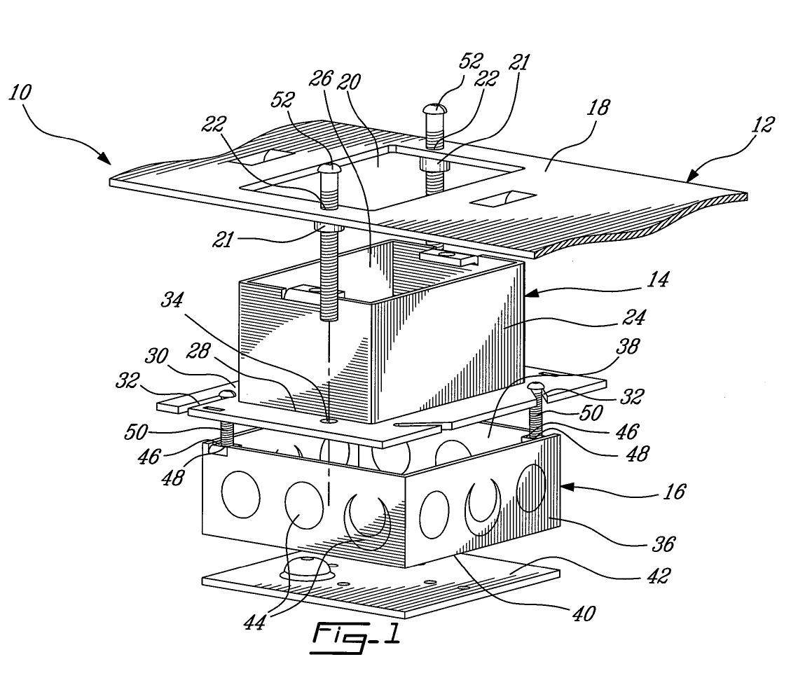

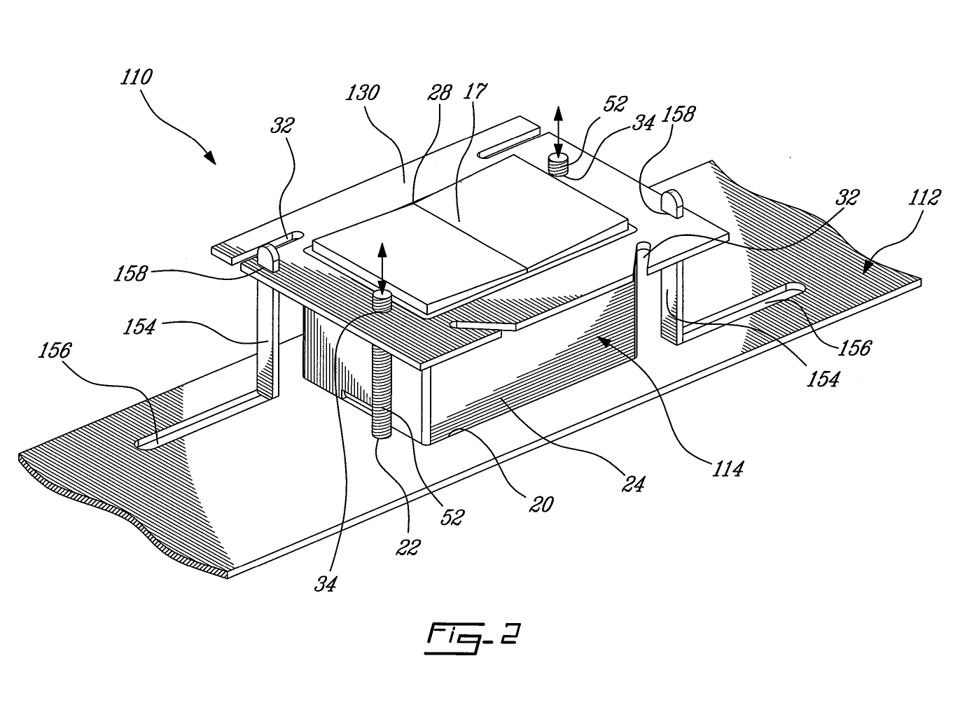

Referring now to FIG. 1, an electrical box assembly 10 according to a particular embodiment of the present invention is shown. The electrical box assembly generally comprises a mounting plate 12, a mud ring or box ring 14 and an electrical box 16. The electrical box assembly 10 can also comprise an electrical component (schematically shown at 17 in FIG. 2) such as for example a switch, a socket, an electrical motor, a speaker, a horn, etc.

The mounting plate 12 includes a flat portion 18 having an opening 20 defined therethrough. The opening 20 generally corresponds to an opening to be defined in the wall covering when the wall partition is closed, such as to have access to the electrical component of the electrical box assembly 10 therethrough. The mounting plate 12 is generally part of an installation bracket designed to be retained within the wall portion, for example by being attached to wall studs, such as shown in U.S. Pat. No. 6,188,022 issued Feb. 13, 2001 to He, the complete specification of which is incorporated herein by reference, or to the floor within the partition, such as shown in U.S. Pat. Nos. 5,423,499 and 6,384,334, both issued to Webb on respectively Jun. 13, 1995 and May 7, 2002, the complete specifications of which are incorporated herein by reference. The mounting plate 12 also includes two apertures 22 defined therethrough on opposite sides of the opening 20 and adjacent diagonally opposed corners thereof, the purpose of which will be described further below. The mounting plate 12 is preferably installed within the partition such that the flat portion 18 is positioned immediately behind the wall covering.

The box ring 14 includes a wall 24 forming a closed perimeter and defining opposed front and rear open ends 26, 28, and a flat plate 30 attached substantially perpendicularly to the wall 24 at the rear end 28 and having an opening (not visible in FIG. 1) defined therethrough corresponding to the rear open end 28. As such the plate 30 defines a flange extending substantially perpendicularly from the wall 24 around the perimeter of the rear open end 28. Although the wall 24 and plate 30 can be integrally formed, for example from a single sheet of material, in a preferred embodiment they are formed separately and assembled together, for example through tabs (not shown) extending from the plate 30 and received in corresponding slots (not shown) in the wall 24 before being folded against the wall 24. Assembling the separate wall 24 and plate 30 together allows for the wall 24 and plate 30 to be substantially perpendicular from one another, for example forming an angle preferably between 85° and 95°, more preferably between 87.5° and 92.5°, and most preferably 90°. Such a box ring construction is shown in U.S. provisional patent application No. 60/829,602 filed Oct. 16, 2006 by the present applicant, the complete specification of which is incorporated herein by reference.

The plate 30 includes slots 32 defined therein, the purpose of which will be defined further below. The plate 30 also includes two threaded apertures 34 defined therethrough (only one being visible in the Figure) on opposite sides of the perimeter of the wall 24 and adjacent diagonally opposed corners thereof, the purpose of which will also be defined further below. The openings 32, which in this embodiment constitute slots, can alternately comprise holes. For example, in lieu of the slots 32, a series of holes can be provided. Further, any combination of such holes and slots 32 can also be used.

The box ring 14 generally at least partially receives and retains the electrical component 17 (see FIG. 2) therein.

The electrical box 16 includes a wall 36 forming a closed perimeter and defining opposed front and rear open ends 38, 40, and a rear cover 42. In one embodiment, the rear cover 42 is removably connected to the wall 36 through appropriate fasteners (not shown) to selectively close the rear end 40. When removable, the rear cover 42 may facilitate the installation of the wiring inside the electrical box 16. However, providing the person installing the assembly can insert wires into the electrical box 16 and have at least some access to work on the appropriate electrical components contained therewithin, the rear cover 42 may be also fixed in place (i.e. not readily removable from the rest of the electrical box). The wall 36 includes a plurality of openings 44 defined therein for receiving electrical wires therethrough. In the embodiment show, the wall 36 of the electrical box 16 defines a rectangular perimeter. Alternately, other types and shapes of electrical boxes can be used, such as electrical boxes having a permanently closed rear end and/or a perimeter wall of a different shape such as for example a square, octagonal or circular perimeter.

The electrical box 16 includes small tabs 46 protruding inwardly from the wall 36 substantially perpendicularly thereto adjacent the front open end 38. In the embodiment shown, two such tabs 46 are defined and are located adjacent diagonally opposed corners of the front end 38. Each tab 46 includes an aperture 48 defined therethrough. These apertures 48 may be threaded, or alternately simply unthreaded through holes if self-tapping fasteners are used. The electrical box 16 is assembled to the box ring 14 by aligning the aperture 48 in each tab 46 with a corresponding slot 32 defined in the plate 30, and by inserting a threaded fastener 50, such as a screw, in each slot 32 and threadingly engaging it into the threaded aperture 48 of the corresponding tab 46. Preferably, the slots 32 in the plate 30 are beveled and the screws 50 are flat headed, and the heads of the screws 50 are substantially received within the slots 32 (i.e. without substantially protruding therefrom) once the box ring 14 and electrical box 16 are assembled together.

The subassembly formed by the interconnected electrical box 16 and box ring 14 is adjustably connected to the mounting plate 12 as described in the following. The opening 20 in the mounting plate 12 is sized such as to slidingly receive the wall 24 of the box ring 14 therein. With the box ring 14 slidingly received in the opening 20 of the mounting plate 12, each aperture 22 defined in the mounting plate 12 is aligned with a corresponding one of the threaded apertures 34 defined through the plate 30 of the box ring 14. At least one adjustment member 52, which in the embodiment shown includes two adjustment screws 52, is received in the aperture 22 of the mounting plate 12 and is threadably engaged with the corresponding aperture 34 of the plate 30. A means for preventing unwanted forward displacement of the adjustment screws 52 is also preferably provided, and which includes, in at least one embodiment such as that shown in FIG. 1, a nut 21 threadably engaged with each of the adjustment screws 52 and located behind the plate 12.

In an alternate embodiment, the apertures 34 in the plate 30 are not threaded and the adjustment members 52 include self tapping screws.

As such, by turning the adjustment screws 52, the position of the box ring 14 (and as such of the electrical box 16 attached thereto) relative to the mounting plate 12 is adjusted, i.e. the distance between the plate 30 and the mounting plate 12 is varied, as such varying the portion of the box ring 14 protruding from the front of the mounting plate 12. Accordingly, a same box ring 14 can be used for wall coverings of various thicknesses, simplifying the installation of the power distribution system within a building. As the adjustment screws 52 are accessible through the front of the mounting plate 12, the depth of the box ring 14 within the wall can be adjusted even after the wall partition is closed and the wall covering is installed, allowing the depth of the box ring 14 to be adjusted when a wall covering is changed or when the depth of the box ring 14 was not adequately set during the initial installation process.

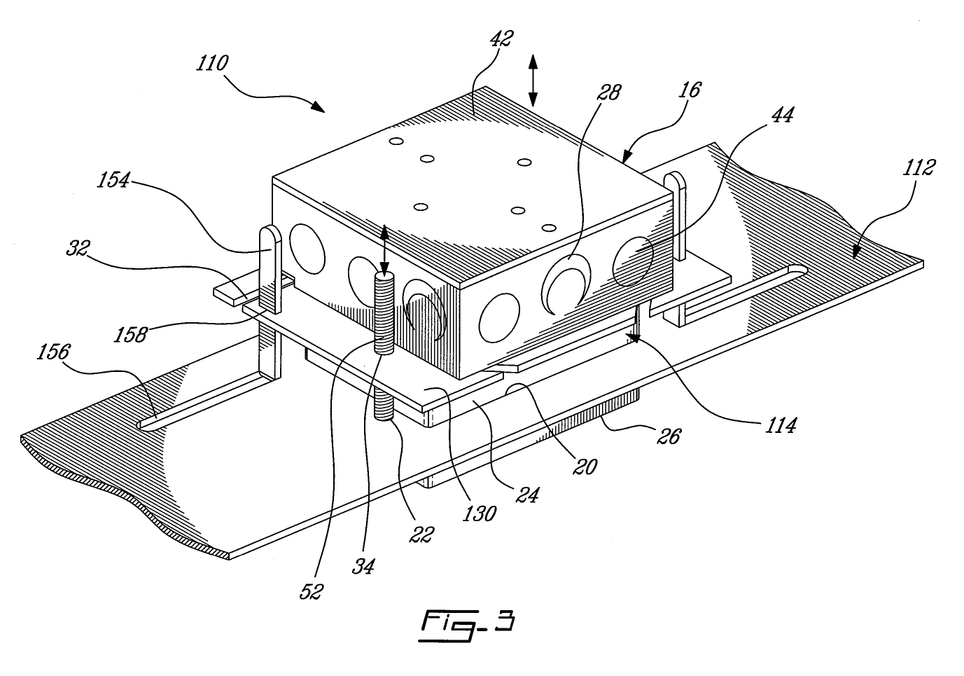

It can be seen that the adjustment screws 52 extend outside the perimeter of the wall 24 of the box ring 14, as well as outside the perimeter of the wall 36 of the electrical box 16, thus avoiding any risk of damaging the electrical equipment therewithin. This is more clearly illustrated in the embodiment shown in FIG. 3.

The slots 32 defined in the plate 30 of the box ring 14 are preferably sized and located such as to be able to accommodate a variety of conventional electrical boxes. As such, only the box ring 14 needs to be adapted for receiving the adjustment members 52, allowing conventional electrical boxes to be used and as such minimizing the costs of having an adjustable electrical box assembly 10.

FIGS. 2-3 show an electrical box assembly 110 according to an alternate embodiment of the present invention, which is similar to the previously shown and described electrical box assembly 10 with the addition of stabilizing members 154 preventing twisting of the box ring 114 during adjustment with the adjustment members 52. Identical elements in both embodiments are identified by the same numbers, and will not be described further herein.

In FIG. 2, the electrical box 16 is omitted for improved clarity. FIGS. 2-3 illustrate the box ring 114 at different positions or depths relative to the mounting plate 112.

The mounting plate 112 thus includes at least two stabilizing members 154 protruding therefrom, preferably formed by having a portion of the mounting plate 112 cut therefrom and folded substantially perpendicularly and rearwardly from a remainder of the mounting plate 112. As such, a slot 156 is defined in the mounting plate 112 adjacent each stabilizing member 154 and corresponding to the shape thereof. As in the previous embodiment, the adjustment members 52 interconnect the box ring 114 and mounting plate 112 on opposite sides of the box ring 114 and adjacent diagonally opposed corners thereof. For improved stability, the stabilizing members 154 are preferably located on the same sides of the box ring 114 as the adjustment members 52, but adjacent the other diagonally opposed corners thereof. Although in the depicted embodiment the stabilizing members 154 are formed from part of the mounting plate 112 itself as this is a relatively cost effective manner in which to provide these protruding stabilizing members, it is also possible to use other means for providing stability and helping to guide the box ring 114 and thus help to prevent unwanted twisting thereof during its displacement. For example, posts may be fastened to the reverse side of the mounting plate 112, such as be welding for example, which protrude therefrom for receipt within corresponding apertures 158 in the plate 130. Alternately still, fasteners may be used for the same purpose, the fasteners being engaged to the mounting plate 112 such as by threaded engagement within holes defined therethrough or using a nut for example. Such fasteners which act as the stabilizing members can include bolts, screw, etc., provided that they permit translation of the box-ring therealong without undue binding.

The stabilizing members 154 are slidingly received within corresponding slots 158 defined through the flat plate 130 of the box ring 114. In the embodiment shown, the length of the stabilizing members 154 is substantially the same as the length of the adjustment members 52, such that the stabilizing members 154 are always engaged in the slots 158 when the adjustment members 52 interconnect the box ring 114 and mounting plate 112.

In an alternate embodiment which is not shown, the electrical box and box ring are integral with one another, i.e. permanently interconnected, such as for example through welding.

In another alternate embodiment not shown, the adjustment members engage the electrical box instead of the box ring. Such an embodiment however necessitates the modification of the electrical box design to receive the adjustment members, for example by having tabs protruding outwardly from the wall of the electrical box with screw-receiving holes defined therethrough.

Further, although the electrical box assemblies described include at least one, and in the embodiment shown, two, adjustment members 52, it is of course possible to use more. For example, three or four such adjustment members may be provided, one proximate each corner of the flat plate of the box ring. Similarly, more than two stabilizing members 154 may be provided.

The embodiments of the invention described above are intended to be exemplary. Those skilled in the art will therefore appreciate that the foregoing description is illustrative only, and that various alternate configurations and modifications can be devised without departing from the spirit of the present invention. Accordingly, the present invention is intended to embrace all such alternate configurations, modifications and variances which fall within the scope of the appended claims.

1. An electrical box assembly comprising:
a mounting plate having an opening defined therein;
a box ring having a wall defining a closed perimeter and opposed open ends, the wall being slidably received within the opening of the mounting plate, and a flange extending outwardly from the wall around one of the open ends of the box ring; and
at least one adjustment member interconnecting the flange and the mounting plate and selectively adjusting a distance therebetween.

2. The electrical box assembly according to claim 1, wherein the at least one adjustment member includes at least one screw having a head located on a side of the mounting plate opposite from the flange.

3. The electrical box assembly according to claim 1, further comprising an electrical box directly connected to the flange.

4. The electrical box assembly according to claim 3, wherein the electrical box is connected to the flange in a detachable manner.

5. The electrical box assembly according to claim 1, further comprising an electrical component received and retained at least partially within the box ring.

6. The electrical box assembly according to claim 5, wherein the electrical component is selected from the group consisting of a switch, a socket, an electrical motor, a speaker and a horn.

7. The electrical box assembly according to claim 1, further comprising at least one stabilizing member extending from one of the mounting plate and the flange, the stabilizing member being received in a corresponding slot defined through the other of the mounting plate and the flange and sliding within the slot when the distance is adjusted.

8. The electrical box assembly according to claim 7, wherein the at least one adjustment member includes two adjustment members each connected to the flange adjacent a respective one of a first pair of diagonally opposed corners of the box ring, and the at least one stabilizing member includes two stabilizing members each extending adjacent a respective one of a second pair of diagonally opposed corners of the box ring.

9. The electrical box assembly according to claim 1, wherein the at least one adjustment member includes two adjustment members each connected to the flange adjacent a respective one of a first pair of diagonally opposed corners of the box ring.

10. The electrical box assembly according to claim 3, wherein the electrical box includes a closed perimeter wall and a rear cover, the rear cover being removably connected to the wall.

11. The electrical box assembly according to claim 1, further comprising means for preventing unwanted forward displacement of the adjustment member relative to the mounting plate.

12. The electrical box assembly according to claim 11, wherein the adjustment member includes a threaded fastener and the means includes a nut engaged thereon.

13. An electrical box assembly comprising:
a mounting plate having an opening defined therein;
a subassembly including a box ring and an electrical box functionally connected to one another, the box ring being slidably received within the opening; and
at least one adjustment member interconnecting the subassembly and the mounting plate and selectively adjusting a relative position thereof.

14. The electrical box assembly according to claim 13, wherein the box ring includes a wall defining a closed perimeter slidably received within the opening, the at least one adjustment member being located outside the closed perimeter.

15. The electrical box assembly according to claim 13, wherein the box ring includes a wall defining a closed perimeter slidingly received within the opening, the wall defining two opposed open ends, the box ring further including a flat plate having an opening defined therethrough, the plate being connected to the wall at one of the open ends substantially perpendicularly thereto such that the opening of the plate is aligned with the open end, and the electrical box is connected to the plate.

16. The electrical box assembly according to claim 15, wherein the at least one adjustment member is adjustably connected to the plate of the box ring.

17. The electrical box assembly according to claim 16, wherein the at least one adjustment member is connected to the plate outside of a perimeter of the electrical box.

18. The electrical box assembly according to claim 13, further comprising an electrical component received within the box ring.

19. The electrical box assembly according to claim 13, further comprising stabilizing members extending from the mounting plate and slidingly received in a respective slot defined in the subassembly.

20. The electrical box assembly according to claim 19, wherein the stabilizing members include first and second stabilizing members extending adjacent diagonally opposed corners of the box ring.

21. The electrical box assembly according to claim 20, wherein the stabilizing members extending adjacent a first pair of diagonally opposed corners of the box ring, the at least one adjustment member including first and second adjustment members extending adjacent a second pair of diagonally opposed corners of the box ring.

22. An electrical box assembly comprising:
a box ring having a wall defining a closed perimeter and opposed first and second open ends, and a plate portion connected substantially perpendicularly to the wall to define a flange extending outwardly around the first open end; and
an electrical box having at least a third open end, the electrical box being directly attached to the plate portion with the first and third open ends aligned with one another.

23. The electrical box assembly according to claim 22, wherein the electrical box is attached directly to the plate portion through removable fasteners such as to be detachable therefrom.

24. The electrical box assembly according to claim 22, further comprising an electrical component received within the box ring.

25. The electrical box assembly according to claim 22, further comprising a mounting flange matingly engaged with the box ring opposite of the electrical box.

26. The electrical box assembly according to claim 22, wherein the mounting flange includes an opening slidingly receiving the wall of the box ring therein, and the mounting flange and the box ring are interconnected in an adjustable manner such that a relative position thereof can be selectively changed.

27. The electrical box assembly according to claim 22, wherein the electrical box includes a rear panel opposite of the third open end and closing a fourth open end when fastened thereto, the rear panel being removable from a remainder of the electrical box.
